(19) United States
(12) Patent Application Publication
(10) Pub. No.: US 2011/0167147 A1
(43) Pub. Date: Jul. 7, 2011

(54) CALCULATING PACKET DELAY IN A MULTIHOP ETHERNET NETWORK

(75) Inventors: Björn Andersson, Porto (PT); Jonas Lext, Trollhattan (SE)

(73) Assignee: Time-Critical Networks AB, Goteborg (SE)

(21) Appl. No.: 12/936,182

(22) PCT Filed: Apr. 9, 2009
(86) PCT No.: PCT/EP2009/054274

§ 371 Date: Feb. 25, 2011

Related U.S. Application Data
(60) Provisional application No. 61/044,029, filed on Apr. 10, 2008.

(51) Int. Cl. G06F 15/173

(52) U.S. Cl. 709/224

(57) ABSTRACT

A method, system, and computer-readable medium for determining the upper bound of the end-to-end delay of a multiframe flow in a multihop Ethernet network. Flows are characterized by the generalized multiframe model, the route of each flow is pre-specified and the output queue of each link schedules Ethernet frames by static-priority scheduling.

### CLAIM OF PRIORITY

The present application claims benefit of priority to U.S. provisional application Ser. No. 61/044,029, filed Apr. 10, 2008, the disclosure of which is incorporated herein by reference in its entirety.

### TECHNICAL FIELD

The present disclosure relates to network analysis, and more particularly, to analysis of the delay of an Ethernet frame in a multihop Ethernet network.

### BACKGROUND

The telephone systems in the 19th century were based on setting up an electrically conducting connection from each of the parties participating in a telephone call. Clearly, the delays were low but signals attenuated rapidly with distance and hence long-distance telephone calls offered poor voice quality. The telephone system became digitized in the 1960's, meaning that the audio from the voice of a person speaking was measured periodically and converted into a digital representation which was periodically transferred across a computer network. The voices from several callers were merged into one data frame. A telephone station sent such a frame periodically which ensured that the voice could stream from source to destination. Long-distance calls were possible and delays were low. But it was difficult to serve bursty data traffic efficiently in such a network and consequently the notion of a packet was proposed. Unfortunately, the delays of packet based networks are highly dependent on the transmission of other packets and hence it is not trivial to find an upper bound on the delay of a packet from its source to its destination. This problem (of sharing network resources and calculating the delay of a packet in a computer network) has therefore been extensively studied, including by different research communities.

The Internet research community traditionally considered computer networks to be shared among a large number of non-cooperative, non-paying users. It is paramount that a single malicious user cannot “clog” the network by sending a large amount of traffic, thereby causing other users to experience no or very slow service from the network. Satisfying soft real-time requirements in this type of network is desirable as well. In particular, offering a low average-case response-time for so-called remote login sessions (such as telnet) was considered important. At first, the aim was not, however, to offer an upper bound on the queuing delay; such a bound would require more detailed characterization of the traffic. For this type of environment, it was found that scheduling the packets to be transmitted on the outgoing link of a switch using the algorithm known as weighted-fair queuing (WFQ) is an appropriate solution.

Researchers in the Internet community realized that carrying voice on a packet network would be of high value to users. Such traffic can be characterized as a stream of data and it has more stringent real-time requirements. For this reason, it was proposed that the outgoing link of a switch be scheduled by an algorithm: packet-by-packet generalized processor sharing (PGPS). PGPS was designed independently of WFQ but both algorithms operate the same way. The traffic was characterized by the so-called leaky-bucket model meaning that it is assumed that the traffic is “smooth” in time. For PGPS applied to traffic characterized by the leaky-bucket model, a method was proposed for computing an upper bound on the delay. A similar method, called network calculus, was developed as well.

The design of a computer network that can offer an upper bound on the delay typically utilizes more than just a scheduling algorithm of the outgoing links of switches. It utilizes an entire architecture for setting up flows, letting users specify the characteristics of resource usage of a new flow, storing established flows and monitoring of established flows. The Tenet architecture is one such architecture with the feature of offering both hard real-time guarantees and statistical real-time guarantees. The resource-reservation protocol (RSVP) is another such architecture, and it later became part of an Internet standard.

The real-time research community studies computer and communication systems where each request to use a resource has an associated deadline. It is assumed that the requests (threads requesting to execute on a processor, or messages requested to be transmitted on a communication link) are accurately described. Algorithms for sharing resources have been proposed and algorithms for computing an upper bound on the delay are typically proposed. The solutions offered have the drawback that designers of computer and communication systems must accurately model the traffic, but they bring several advantages such as (i) often the algorithms for sharing a resource fail to satisfy timing requirements, but only if it is impossible to satisfy all timing requirements, and (ii) the delay bounds computed are often close to the best possible for the scheduling algorithm used. These algorithms are typically used for safety-critical computer systems such as drive-by-wire systems in cars, control systems in space stations, control systems in nuclear power plants and critical medical control systems.

The Controller Area Network (CAN) bus is a communication technology typically used in embedded real-time systems. A set of computer nodes, equipped with CAN controllers can request to transmit on the bus (a shared wire) and the request with the highest priority is granted access to the bus. As a result of this behavior, designers can (given a characterization of the traffic, for example minimum inter-arrival times of message transmission requests) compute an upper bound on the delay from when a message is requested to be transmitted until it has successfully been transmitted. Such guarantees can actually be offered although the exact time of a message transmission request is unknown. Designers are typically however interested in end-to-end delays across several networks and other resources that are shared. For this purpose, the real-time systems community created a framework, called holistic schedulability analysis, for composing delays of single resources into an end-to-end delay. The analysis of the CAN bus can be incorporated into this framework.

Ethernet was originally a technology for letting a number of users share a medium, such as a coaxial cable, for the purpose of communication. It has enjoyed great success for desktop personal computers in offices because of its simplicity and its high bit-rate. Ethernet was originally deemed unsuited for hard real-time applications however because an upper bound on the delay could not be proven. The reason is that the algorithm for granting access to the medium used by Ethernet is randomized and hence a collision could occur, meaning that two computers may transmit simultaneously causing none of them to transmit successfully. Ethernet evolved however, away from using a shared medium to the use of Ethernet switches, where each computer is connected through a dedicated wire to the Ethernet switch. Collisions were hence eliminated and this fostered a significant interest in using Ethernet in real-time systems, particularly in factory automation. An analysis of priority-based scheduling in an Ethernet switch has been presented (H. Hoang, M. Jonsson, U. Hagström, and A. Kallerdahl, “Switched Real-Time Ethernet and Earliest Deadline First Scheduling—Protocols and Traffic Handling,” presented at Workshop on Parallel and Distributed Real-Time Systems, Fort Lauderdale, (2002), incorporated herein by reference) but was lacking in many respects, particularly that it could not apply to multihop networks.

In the context of factory automation, several researchers have pointed out that the real-time guarantees that are computed are based on the assumption that no nodes misbehave. They argue that factory automation is such a critical application that the network must be improved to ensure that such malicious computer nodes cannot violate the real-time guarantees by other computed nodes. Two solutions, traffic shaping performed by endhosts and time-division multiplexing implemented in the switch have been proposed.

The Internet community and the real-time research community are largely separated, however, with no comparisons among the solutions proposed. One notable exception is Sjödin's work on using the response-time calculus (from the real-time systems community) in order to analyze the delay of Internet traffic carried on Asynchronous Transfer Mode (ATM) links (see M. Sjödin, “Predictable High-Speed Communications for Distributed Real-Time Systems,” in Department of Computer Systems. Uppsala: Uppsala University, (2000), incorporated herein by reference). It was found that the response-time calculation performs better than weighted-fair queuing and its variants. However, Sjödin's work did not apply to Ethernet technologies.

A clear trend seen in Internet data traffic is an increase in the numbers of real-time flows. A characteristic of a real-time flow is that if data packets sent by a source host fail to reach the destination host within a certain time span, or do not arrive periodically, the experienced quality of the application suffers. A service like video-on-demand exhibits a softer form of real time demand; by delaying the presentation and collecting a buffer of video frames, one can protect the application against contention on the Internet that temporarily interrupts the transmission. For the most demanding real-time applications, however, buffering can in much less extent, or not at all, protect against temporary interruptions in the transmission. These applications are typically distributed, interactive applications, like Voice over IP (VoIP), video conferencing, multi-user games etc. Implicitly, these applications can often be associated with a deadline; if a data packet arrives to the destination host after its deadline, the user experiences a lower quality. If the delay of the transmission becomes too large, the users of, e.g., a VoIP application will find it impossible to speak and will terminate the call in frustration.

The Internet is built to handle best-effort traffic, not real-time flows. The data networks that comprise the Internet and the protocols that regulate the traffic sent over these networks are built to handle best-effort traffic. Generally, these have not been designed to handle real-time flows. Instead, one relies on a certain amount of overcapacity in the network, so that contention does not occur. Admittedly, in later years, the insight that different applications are associated with different demands on quality of service (QoS) has been made. For example, there are now Internet standards that allow the traffic to be divided into eight different classes which have Internet switches and routers prioritize the traffic classes differently. However, a single network still cannot offer any guarantees that a prioritized application will satisfy its implicit deadlines. Different traffic flows within the same class also need to be prioritized differently; for example a VoIP-call from Stockholm to Gothenburg does not need as high priority over a single link as a call from Tokyo to Gothenburg needs over the same link. Furthermore, the network operators have probably difficulties deciding if a network is near to be overloaded and even more difficulties to decide if individual traffic flows make their implicit deadlines. The fundamental problem is that applications and protocols does not recognize that they share the same network equipment to send time critical data, and that the network equipment does not regulate how different traffic flows get access to the network resources.

### SUMMARY

In one aspect, the technology provides a method for calculating the end-to-end delay of a multiframe real-time flow along a route in a multihop network, the method comprising: selecting the route in the multihop network, wherein the multiframe real-time flow is capable of being transmitted along the route, the route comprising a source node in the multihop network, a destination node in the multihop network, and at least one intermediate node in the multihop network, the source node comprising either an IP-endhost or an IP-router, the destination node comprising either an IP-endhost or an IP-router, and the multiframe flow comprising one or more frames; and determining an upper bound of the time required to transmit the multiframe real-time flow from the source node to the destination node along the selected route.

In another aspect, the technology provides a method for analyzing the schedulability of a multiframe real-time flow in a multihop network, the method comprising: selecting a route in the multihop network, wherein the multiframe real-time flow is capable of being transmitted along the route, the route comprising a source node in the multihop network, a destination node in the multihop network, and at least one intermediate node in the multihop network, the source node comprising either an IP-endhost or an IP-router, the destination node comprising either an IP-endhost or an IP-router, and the multiframe flow comprising one or more frames; looking up the end-to-end delay of the multiframe real-time flow along the selected route in the multihop network; and determining whether it is possible to offer a delay guarantee for the multiframe real-time flow, wherein the delay conforms to a specified deadline for the arrival of the multiframe real-time flow at the destination node, given the upper bound of the time required to transmit the multiframe real-time flow from the source node to the destination node along the selected route.

In another aspect, the technology provides a computer program, tangibly stored on a computer-readable medium, for calculating an upper bound of the time required to transmit a multiframe real-time flow along a route in a multihop network, the computer program comprising instructions for causing a computer to: receive input selecting the route in the multihop network, wherein the multiframe real-time flow is capable of being transmitted along the route, the route comprising a source node in the multihop network, a destination node in the multihop network, and at least one intermediate node in the multihop network, the source node comprising either an IP-endhost or an IP-router, the destination node comprising either an IP-endhost or an IP-router, and the multiframe flow comprising one or more frames; and calculate an upper bound of the time required to transmit the multiframe real-time flow from the source node to the destination node along the selected route.

In another aspect, the technology provides a system for calculating an upper bound of the time required to transmit a multiframe real-time flow along a route in a multihop network, the system comprising: means for receiving input selecting the route in the multihop network, wherein the multiframe real-time flow is capable of being transmitted along the route, the route comprising a source node in the multihop network, a destination node in the multihop network, and at least one intermediate node in the multihop network, the source node comprising either an IP-endhost or an IP-router, the destination node comprising either an IP-endhost or an IP-router, and the multiframe flow comprising one or more frames; and means for calculating an upper bound of the time required to transmit the multiframe real-time flow from the source node to the destination node along the selected route.

In another aspect, the technology provides a system for analyzing the schedulability of a multiframe real-time flow in a multihop network, the system comprising: selecting a route in the multihop network, wherein the multiframe real-time flow is capable of being transmitted along the route, the route comprising a source node in the multihop network, a destination node in the multihop network, and at least one intermediate node in the multihop network, the source node comprising either an IP-endhost or an IP-router, the destination node comprising either an IP-endhost or an IP-router, and the multiframe flow comprising one or more frames; looking up the end-to-end delay of the multiframe real-time flow along the selected route in the multihop network; and determining whether it is possible to offer a delay guarantee for the multiframe real-time flow, wherein the delay conforms to a specified deadline for the arrival of the multiframe real-time flow at the destination node, given the upper bound of the time required to transmit the multiframe real-time flow from the source node to the destination node along the selected route.

The methods herein are advantageous at least because (i) they are capable of incorporating the delays because of finite speed of the processor inside the switch, (ii) they are more truthful to reality in that the non-preemptive aspect of communication is modeled, (iii) they can analyze multihop networks, and (iv) they take jitter into account and shows how it propagates throughout the pipeline of resources.

The details of one or more embodiments of the technology are set forth in the accompanying drawings and the description below. Other features, objects, and advantages of the technology will be apparent from the description and drawings, and from the claims.

### DESCRIPTION OF DRAWINGS

FIG. 1 is a schematic of a network with Ethernet switches. Nodes 0,1,2 and 3 are IP-endhosts (e.g., PCs running video-conferencing applications). Nodes 4,5 and 6 are Ethernet switches. Node 7 is an IP-router that connects the Ethernet network to the global Internet.

FIG. 2 is a schematic example of a route through the network in FIG. 1; the source node is node 0 and the destination node is node 3. This figure shows how the nodes forward packets of the flow. The arrivals of packets on node 0 are characterized by the generalized multiframe model.

FIG. 3 is a representation of a sequence of MPEG frames (i.e., UDP packets), characterized as IBBPBBPBB; a movie is comprised of a repetition of this sequence of MPEG frames. The P-frame stores the frame as the difference between the previous I- or P-frame. The B-frame stores the frame as the difference between the previous I-frame or P-frame or the next I-frame and P-frame. For this reason, the transmission order is as shown in the figure.

FIG. 4 is an illustration of the parameters describing traffic over a specific link; here the link considered is link(0.4). Part of this figure is a subset of FIG. 3, focusing on the link from node 0 to node 4.

FIG. 5 is a representation of a software-implemented Ethernet switch. Arrows indicate the flow of Ethernet frames. A dashed line indicates the possible paths of an Ethernet frame. A gray circle indicates a software task.

FIG. 6 illustrates a decomposition of a flow described by the generalized multiframe model into UDP packets and Ethernet frames and how these Ethernet frames pass through the network.

FIG. 7 illustrates one embodiment of the hardware underlying a network node.

Like reference symbols in the various drawings indicate like elements.

### DETAILED DESCRIPTION

### Introduction

Many recent, distributed, real-time applications are sensitive to Internet communication delay.

In most instances, a low delay is desired. The finite speed of light causes significant delays for traffic over large geographical distances; this cannot be reduced with better networking equipment. The delay due to queuing of a packet because other less time-critical packets are ahead in a queue can however be controlled by networking equipment.

Hops in the core of the Internet tend to have small queuing delay because of overprovisioning. The traffic in the core is an aggregation of a large number of independent flows and hence (due to the law of large numbers) the delay in the core has low variance as well; consequently an upper bound on the delay of hops in the core network can be estimated from measurements. Practitioners have therefore suggested that Quality of Service (QoS) techniques are most useful at the edge of the Internet.

The edge of the Internet is heavily reliant on Ethernet technology, and prioritized switches are becoming common there. Typically, a higher priority is given to Ethernet frames from one incoming interface, or Ethernet frames carrying voice, but unfortunately those networks do not use scheduling theory in order to find an upper bound on the delay. According to the instant disclosure, however, schedulability analysis plays an important role at the edge of the Internet because: (i) Ethernet switches are based on point-to-point communication, and hence there are no problems with random backoffs in the medium access, as was the case in the traditional shared-coaxial-cable/hub-based Ethernet used in the past; (ii) queuing delays in outgoing queues in Ethernet switches can be controlled with static-priority scheduling according to the IEEE 802.1p standard, where a specific frame-format of the Ethernet frame specifies the priority; (iii) many commercially available Ethernet switches support 2-8 priority levels and can operate according to the IEEE 802.1p standard; and (iv) many networking applications today need to meet deadlines.

Given the capability of current infrastructure and application needs it is worthwhile to develop architectures for achieving real-time guarantees of packet delays on the Internet. Such architectures have been considered (RSVP is one of them) but did not achieve widespread adoption. According to the instant disclosure, offering real-time guarantees at the edge of the Internet, and also in internal corporate networks and metropolitan networks, is easier to adopt because it is typically owned by a single organization and hence it brings simplifications such as: (i) the resource reservation (as a result of a flow being accepted by an admission test) can be performed without billing, and (ii) complete knowledge of topology is possible.

According to the instant disclosure, an optimal way to handle time critical traffic over a network is to develop equipment, protocols and applications based on theories from real-time computing research. This research area has for several years addressed the problem of how resources should be shared to achieve individual timing requirements. Such theories are used today in highly critical computer systems and networks in environments such as: (i) the international space station, (ii) rocket launchers, and (iii) fly-by-wire systems in intercontinental aircraft. But those theories have not yet been used in the context of the Internet.

The terms schedulability analysis and scheduling algorithm are central in real-time research; scheduling algorithms decide when different users should get access to resources that are shared between them. Using schedulability analysis, one can decide if a resource can be shared in time such that all users can accomplish their tasks before critical deadlines.

In the instant disclosure, schedulability analysis and scheduling algorithms are used to handle real-time flows sent over Ethernet and IP-networks. In essence, these networks then receive a new Internet service models. In, e.g., a corporate network in which the corporation controls all switches, such a service model delivers the following benefits: (1) The ability to decide if a new real-time flow can be transferred over the network, so that its real-time demands are meet without violating the real-time demands of already committed flows. All admitted flows are then sent with delay guarantees, i.e., the individual data packets of all flows will be delivered to their destinations within specified time frames. (2) Reject a flow, if the network is close to being overloaded. (Today this is not the case, resulting in all flows within a certain priority class that experiences reduced quality.) (3) If several different paths exist through the network from a source to a destination host, the methods used herein can identify a path that optimizes a certain metric while ensuring that deadlines are met. (4) Evaluate the utilization of each network node and each network link, making it easy for the network operator to identify “hot spots” in the network.

To achieve the benefits mentioned hereinabove, we need a way to find an upper bound on the delay the packets of a new real-time flow will experience when traveling through a multihop network already populated with other flows and best-effort traffic. The instant disclosure comprises unique formulas for calculating a bound of the packet delay in a setting where the network nodes are software implemented Ethernet switches. The formulas can be used in the implementation of a network control mechanism that admits real-time flows into the network in accordance with the four points in the preceding paragraph. The architecture can be either centralized (i.e., a single server implements the control mechanism) or distributed over all the network nodes. The formulas can be implemented in software or hardware. Particularly, a real-time flow admitted by the control mechanism is guaranteed to transfer packets in a time less than a requested end-to-end delay.

Proving an upper bound on the end-to-end delay requires that pipelines of resources are analyzed. For this purpose, the real-time computing community has proposed a framework, called holistic schedulability analysis which has been used successfully in automotive systems, but which has not yet been used for IP- or Ethernet traffic. In addition, the holistic schedulability analysis was developed for the sporadic model which is not a good match for, e.g., MPEG encoded video-traffic. Another model, the generalized multiframe model, is set up to allow designers to express different sizes of video frames, but it was not proposed for use in multihop communication; so far it has only been used to schedule a single resource. No previous work exists for computing an upper bound on the delay of flows characterized by the generalized multiframe model in multihop networks. In particular, no previous work exists for computing an upper bound on the delay of flows characterized by the generalized multiframe model in multihop networks when the outgoing queues in switches are scheduled by static-priority scheduling.

Flows are characterized by the generalized multiframe model, the route of each flow is pre-specified and the output queue of each link schedules Ethernet frames by static-priority scheduling. Ethernet switches are viewed as being implemented in software; this can be performed with, e.g., Click, an open-source software package that implements the basic functionalities of an Ethernet switch. We have used Click to implement an Ethernet switch with prioritized output queues, and measured important characteristics of the implementation. The Click software uses stride scheduling for scheduling software tasks inside the Ethernet switch. Hence those delays must be analyzed as well.

We consider the problem of satisfying real-time requirements from the perspective of a network operator who manages switches in the edge of the Internet and who is asked to offer delay guarantees to pre-specified flows. This requires that the network can identify which flow an incoming Ethernet frame belongs to; the problem can be solved, but it is not the subject of the instant patent application. As a network operator, it is only possible to control queuing discipline in the Ethernet switches—not the queuing discipline in the source node(s).

### Exemplary Embodiments

Consider the problem of computing an upper bound on the response-time of a User Datagram Protocol (UDP) packet in a multihop network comprising software-implemented Ethernet switches. The assumptions made and their relations to applications for this platform are described in this section.

### Network Model

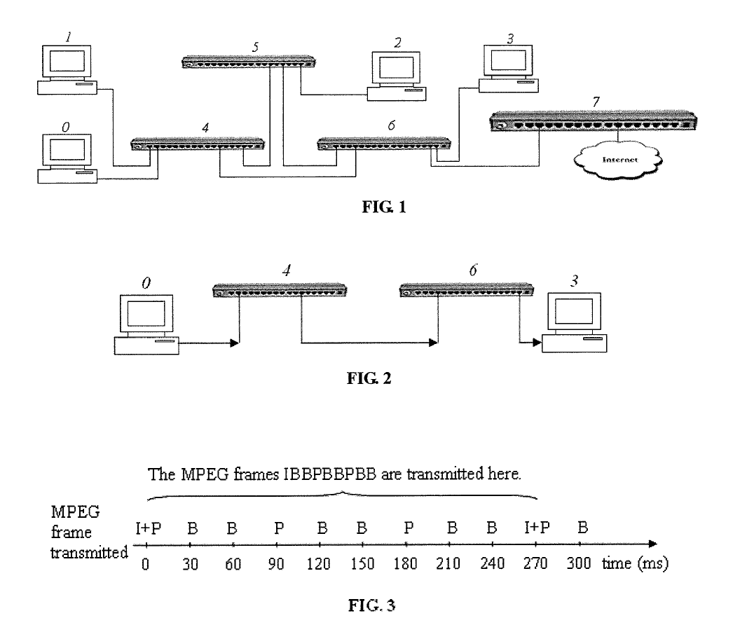

FIG. 1 depicts an example of the type of network considered. The network comprises nodes (e.g., 0-7); some are Ethernet switches (e.g., 4, and 6), some are IP-endhosts (e.g., 0, 1, 2, and 3) and some are IP-routers (e.g., 5 and 7). On an IP-endhost there are one or many processes; each process is associated with one or many flows. For example, a process may be a video conferencing application and it may be associated with two flows: one for video and one for audio. A flow releases a (potentially infinite) sequence of UDP packets on the source node and these packets are relayed to the destination node by Ethernet switches.

The source node of a flow is either an IP-endhost or an IP-router. Analogously, the destination node of a flow is either an IP-endhost or an IP-router. The flow is associated with a route from the source to the destination; this route traverses only Ethernet switches—the route does not traverse IP-routers. FIG. 2 shows an example of a route (between nodes 0 and 3, via switches 4 and 6). Note that an IP-router may be a source node and then the destination node may be an IP-endhost; this happens if another node (outside the network we consider) sends data to the IP-endhost, but we are only studying Ethernet networks and for this reason, the IP-router is the source node of the flow that is analyzed.

A flow releases a (potentially infinite) sequence of transmission requests where each transmission request means a request to transmit a UDP packet. A packet could be for example an I-frame in an MPEG encoded video sequence. A UDP packet may be transmitted as a single Ethernet frame or it may be fragmented into several Ethernet frames. The Ethernet switches are not aware of the UDP packet; they are only aware of Ethernet frames. Despite this fact, the traffic over the Ethernet network may be described using UDP packets, and each UDP packet may be treated as a job in processor scheduling. Naturally this requires some adaptation, such as introduction of a blocking term, and a new type of jitter, called generalized jitter (explained hereinbelow).

A transmitted Ethernet frame is received by another node. If this other node is the destination node of the flow then we say that the response time of the packet in the flow is the maximum time from when the UDP packet is enqueued at the source node until the UDP packet is received at the destination node of the flow. We say that the UDP packet is received at the destination node of the flow at the time when the destination node has received all Ethernet frames belonging to the UDP packet.

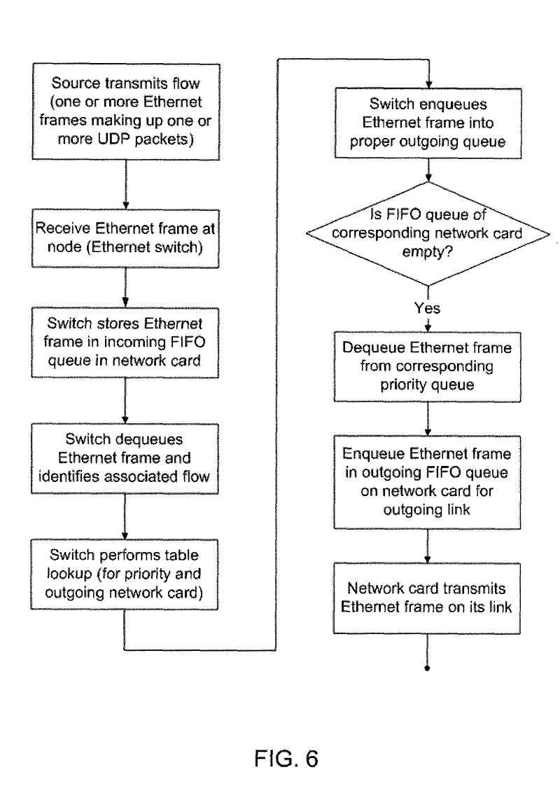

FIG. 5 shows, schematically, various internal components of an Ethernet switch, and FIG. 6 illustrates the decomposition of a flow described by the generalized multiframe model into UDP packets and Ethernet frames, and how these Ethernet frames pass through the network. If the node receiving an Ethernet frame is not the destination node of the flow then it is an Ethernet switch. The Ethernet switch receiving the Ethernet frame stores the Ethernet frame in a first-in-first-out (FIFO) queue in the network card. The processor in the Ethernet switch dequeues the Ethernet frame from this FIFO queue and identifies the flow that the Ethernet frame belongs to. Based on this identification, the switch looks up in a table the outgoing network card that should be used and looks up the priority that the Ethernet frame should use. Each outgoing network interface has a corresponding priority queue, stored in main-memory. The Ethernet frame is enqueued into the proper outgoing queue. There is one software task for each ingoing network interface and this task performs this work. Each outgoing queue has a software task as well which checks if the FIFO queue of its corresponding network card is empty and, if this is the case, it dequeues an Ethernet frame from its corresponding priority queue and enqueues this Ethernet frame into the FIFO queue on the network card of the outgoing link. The network card naturally transmits the Ethernet frame on the link corresponding to the network card.

Let link(N₁,N₂) denote the link between node N₁ and node N₂, linkspeed(N₁,N₂) denote the bitrate of link(N₁,N₂) and prop(N₁,N₂) denotes the propagation delay (due to the finite speed of light) of link(N₁,N₂).

Measurements of this implementation suggest that the uninterrupted execution time required for dequeuing an Ethernet frame from the incoming network card until it enqueues the Ethernet frame in the priority queue is 2.7 μs. Measurements also suggest that the uninterrupted execution time required for dequeuing an Ethernet frame from the outgoing queue until it enqueues the Ethernet frame in the FIFO queue of the network card is 1.0 μs. It is assumed that a single processor is used in the Ethernet switch and the processor is scheduled with stride scheduling.

Stride Scheduling

Stride scheduling is designed to (i) service tasks according to a pre-specified rate, and (ii) have a low dispatching overhead. It works as follows. Each task is associated with a counter (called pass) and two static values: tickets and stride. The system also has a large integer constant. The stride of a task is this large integer divided by the ticket of a task. When the system boots, the pass (which is the counter) of a task is initialized to its stride. The dispatcher selects the task with the smallest value of pass; this task may execute until it finishes execution on the processor and then its pass is incremented by its stride. With this behavior, a task with ticket=2 will execute twice as frequently as a task with ticket=1. The amount of processing time used by the former task is not necessarily twice as much as that used by the latter, though.

Stride scheduling can be configured such that each task has a ticket=1; this causes stride scheduling to collapse to round-robin scheduling; this is the configuration we use herein (this is the default configuration in Click).

### Traffic Model

As already mentioned, it is assumed that the sequence of transmission requests can be described with the generalized multiframe model. This model was originally developed for characterizing arrivals of jobs in processor scheduling, but as described herein it can be used for characterizing traffic in networks as well. The original generalized multiframe model did not model jitter. The methods described herein introduce jitter to the model, but the notion of jitter is slightly different from the normal notion of jitter, and is referred to herein as generalized jitter.

A flow τᵢ is a (potentially infinite) sequence of messages. FIG. 3 gives an illustration of an MPEG stream. The MPEG stream requests to transmit UDP packets which are characterized by the generalized multiframe model. We are interested in finding the response time of a flow from source to destination. In order to do that, the response time of the flow across a single resource (such as a link), is calculated. And consequently, it is necessary to describe how frequently the flow requests to use this resource, and how much of the resource that it needs. The actual time needed depends on the characteristics of the resource, such as the link speed.

A flow τᵢ is described with a tuple Tᵢ, a tuple Dᵢ, a tuple GJᵢ, a tuple Sᵢ and a scalar nᵢ. The scalar nᵢ represents the number of “frames” of the flow; these frames should not be confused with Ethernet frames. The flow for sending the MPEG stream given by FIG. 3 has nᵢ=9 because there are 9 frames and then it repeats itself. The first frame is the UDP packet “I+P”; the second frame is the UDP packet “B”, and so on.

Let |Tᵢ| denote the number of elements in the tuple Tᵢ. Then it holds that |Tᵢ|=|Dᵢ|=|GJᵢ|=|Sᵢ|nᵢ. The first element in the tuple Tᵢ is indexed Tᵢ⁰ and it represents the minimum amount of time between the arrival of the first frame τᵢ of and the second frame of τᵢ at the source node. Analogously, for Tᵢ¹, Tᵢ², . . . , Tᵢⁿⁱ⁻¹. Note that the exact times of transmission request of any frame is unknown; only lower bounds of inter-arrival times are known.

When a frame has arrived on the source node, it releases its Ethernet frames, but all Ethernet frames are not necessarily released simultaneously. If t denotes the time when the first Ethernet frame of frame k of flow τᵢ is released, then all Ethernet frames of this frame are released during [t, t+GJᵢ^{k}). It can be seen that if all Ethernet frames of a frame would be released simultaneously, and if Ethernet frames were arbitrarily small then our notion of jitter would be equivalent to the normal notion of jitter used in preemptive processor scheduling. Since GJᵢ^{k} is a generalization, we say that GJᵢ^{k} is the generalized jitter of frame k in flow τᵢ.

The first element in the tuple Dᵢ is indexed Dᵢ⁰ and it represents the relative deadline of the first frame; meaning that the first frame must reach the destination node within Dᵢ⁰ time units from the arrival on the source node. Analogously, for Dᵢ¹, Dᵢ², . . . , Dᵢⁿⁱ⁻¹.

The first element in the tuple Sᵢ is indexed Sᵢ⁰, and it represents the number of bits in the payload of the packet of the first frame. Analogously, for Sᵢ¹, Sᵢ², . . . , Sᵢⁿⁱ⁻¹.

### Schedulability Analysis

### Basic Parameters

Parameters for each link of each frame of a flow can be computed as follows. By knowing the number of bits of payload in a UDP packet, it is possible to compute the transmission time of the UDP packet over a link with known link speed. A UDP packet must have an integral number of bytes and it must also include the UDP header (8 bytes). Let nbitsᵢ^{k} denote the number of bits that constitute the UDP frame (including the UDP header) of the kth frame of flow τᵢ. Accordingly:

$${nbits}_{ i}^{ k} = ⌈ \frac{{S}_{i}^{ k}}{8} ⌉ \times 8 + 8 * 8$$

If Real-Time Transport Protocol (RTP) is used then it is necessary to add 16 bytes for the RTP header. Hence:

$${nbits}_{ i}^{ k} = ⌈ \frac{{S}_{i}^{ k}}{8} ⌉ \times 8 + 8 \times 8 + 16 \times 8$$

The IP-header (20 bytes) must also be added. An Ethernet frame has a data payload of 1500 bytes and a header (14 bytes), CRC (4 bytes) and preamble+start-frame delimiter (8 bytes), and inter-frame gap (12 bytes). Therefore, an Ethernet frame has a maximum size of 12304 bits. Although the payload is 1500 bytes; 20 bytes of them are for the IP-header and hence there is room for 1480 bytes (=11840 bits) of data in each Ethernet frame. This means that Cᵢ^{k,link(s,d)}, the transmission time of the UDP packet which is frame k of flow τᵢ on link(s,d), can be computed as:

$${C}_{i}^{k , link ( s , d )} = \frac{⌊ \frac{{nbits}_{i}^{k}}{11840} ⌋ \times 12304}{linkspeed ( s , d )}$$

$$if ⌊ \frac{{nbits}_{ i}^{ k}}{11840} ⌋ \times 11840 \neq {nbits}_{ i}^{ k} then$$

$${C}_{i}^{k , link ( s , d )} = {C}_{i}^{k , link ( s , d )} + \frac{{nbits}_{ i}^{ k} - ⌊ \frac{{nbits}_{i}^{ k}}{11840} ⌋ \times 11840 + 304}{linkspeed ( s , d )}$$

end if

Let MFT (Maximum-Frame-Transmission-Time) be denoted as:

$${MFT}^{link ( s , d )} = \frac{12304}{linkspeed ( s , d )} \qquad ( 1 )$$

Let us consider the traffic in the MPEG stream in FIG. 3 on the route given in FIG. 2; call it flow Consider the link from node 0 to node 4 and assume that linkspeed(0,4)=10⁷ bit/s.

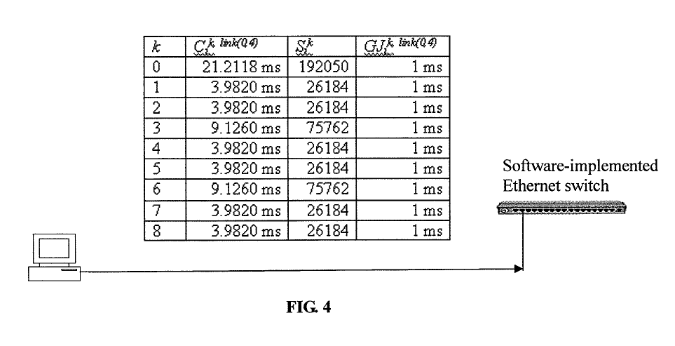

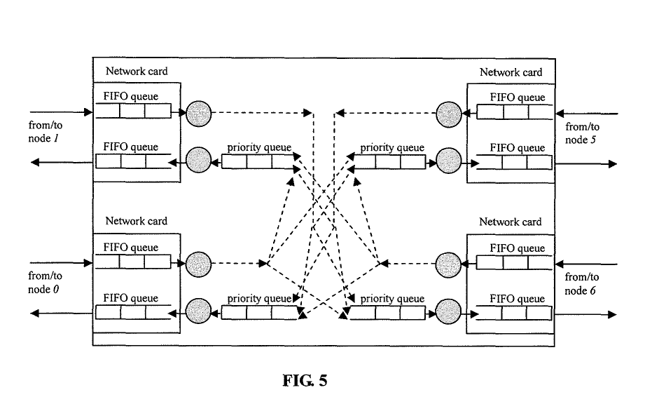

Calculations of Cᵢ^{k,link(0,4)} based on (1) and (2) (hereinbelow) yield the values shown in FIG. 4. The parameters Cᵢ^{k} for the other links link(4,6) and link(6,3) can be obtained analogously. FIG. 3 shows the MPEG stream, assuming no generalized jitter. In practice, however, there is generalized jitter; for the illustration in FIG. 4 a generalized jitter of 1 ms is assumed.

To compute the response time of a frame k of a flow from source to destination requires that a pipeline of resources (each with a queue) is analyzed. The response time of the first resource is computed and becomes additional generalized jitter to the 2^{nd} resource. The response time of the 2^{nd} resource and so on are computed by taking this generalized jitter into account. Finally, the response time from source to destination is obtained by adding the response times of all resources. If the response time from source to destination of every frame of a flow does not exceed its corresponding deadline, then the flow meets all its deadlines.

The generalized jitter can be indexed in two different ways. GJᵢ^{k} is the generalized jitter of the frame k of flow i of the source node; this is a specification of the flow. GJᵢ^{k,link(N1,N2)} represents the jitter of frame k of flow i on the link from node N₁ to N₂; this will be calculated, as further described herein.

In the analysis performed in this section, some short-hand notations are useful. flows(N₁,N₂) denotes the set of flows over the link from node N₁ to node N₂. hep(τᵢ, N₁, N₂) denotes the set of flows over the link from node N₁ to node N₂ which have higher priority than flow r, or equal priority as τᵢ. succ(τⱼ,N) denotes the node that is the successor of node N in the route of the flow τⱼ. Analogously, prec(τⱼ,N) denotes the node that is the predecessor of node N in the route of the flow τⱼ. hep(τⱼ,N) and lp(τⱼ,N) represent higher- and lower-priority flows, leaving node N. Formally they are expressed as:

hep(τᵢ,N)={j:(j≠i)̂(jεflows(N,succ(τᵢ,N)))̂(prio(j,N,succ(τᵢ,N))≧prio(i,N,succ(τᵢ,N)))} (2)

and

lp(τᵢ,N)=(flows(N,succ(τᵢ,N))\hep(i,N))\{i} (3)

Further definitions follow below:

$$\begin{matrix}{CSUM}_{j}^{link ( {N}_{1} , {N}_{2} )} = {\sum }_{k = 0}^{{n}_{j} - 1} {C}_{j}^{k , link ( {N}_{1} , {N}_{2} )} \\ and & ( 4 ) \\ {NSUM}_{j}^{link ( {N}_{1} , {N}_{2} )} = {\sum }_{k = 0}^{{n}_{j} - 1} ⌈ \frac{{C}_{j}^{k , link ( {N}_{1} , {N}_{2} )}}{{MFT}^{link ( {N}_{1} , {N}_{2} )}} ⌉ \\ and & ( 5 ) \\ {TSUM}_{j} = {\sum }_{k = 0}^{{n}_{j} - 1} {T}_{j}^{k} & ( 6 )\end{matrix}$$

Intuitively, (4) calculates the sum, CSUM, of the transmission times of all nⱼ frames of flow τⱼ. Using the example in FIG. 4, the following is obtained:

CSUMⱼ^{link(N}^{₁}^{,N}^{₂}⁾=63.3628 ms

Equation (5) calculates the number of Ethernet frames of all nⱼ frames of flow τⱼ. Using the example in FIG. 4, gives:

NSUMⱼ^{link(N}^{₁}^{,N}^{₂}⁾=49

Equation (6) calculates a lower bound on the amount of time from when a frame of flow τⱼ is requested until this frame is requested again. Using the example in FIG. 4, the following is obtained:

TSUMⱼ=270 ms

Later in the analysis, it is necessary to consider a sequence of frames. Equations (7), (8) and (9) present such expressions for a sequence of frames, based on equations (4), (5) and (6) herein.

$$\begin{matrix}{CSUM}_{j}^{link ( {N}_{1} , {N}_{2} )} ( {k}_{1} , {k}_{2} ) = {\sum }_{k = {k}_{1}}^{{k}_{1} + {k}_{2} - 1} {C}_{j}^{k mod {n}_{j} , link ( {N}_{1} , {N}_{2} )} \\ and & ( 7 ) \\ {NSUM}_{j}^{link ( {N}_{1} , {N}_{2} )} ( {k}_{1} , {k}_{2} ) = {\sum }_{k = {k}_{1}}^{{k}_{1} + {k}_{2} - 1} ⌈ \frac{{C}_{j}^{k mod {n}_{j} , link ( {N}_{1} , {N}_{2} )}}{{MFT}^{link ( {N}_{1} , {N}_{2} )}} ⌉ \\ and & ( 8 ) \\ {TSUM}_{j} ( {k}_{1} , {k}_{2} ) = {\sum }_{k = {k}_{1}}^{{k}_{1} + {k}_{2} - 2} {T}_{j}^{k mod {n}_{j}} & ( 9 )\end{matrix}$$

Observe that the ranges of summation in (4), (5) and (6) are the same as one another, whereas the range of summation in (9) is different from the range of summation in (7) and (8).

MXS(τⱼ,N₁,N₂,t) denotes an upper bound on the amount of time that flow τⱼ uses the link from node N₁ to node N₂ during a time interval of length t. (S in MXS means small). MXS is only defined for values of t such that 0<t<TSUMⱼ. The function MXS as used herein is:

$$MXS ( {τ}_{j} , {N}_{1} , {N}_{2} , t ) = min ( t , {max}_{{k}_{1} = 0 … {n}_{j} - 1 , {k}_{2} = 1 … {n}_{j} such that {TSUM}_{j} ( {k}_{1} , {k}_{2} ) \leq t} {CSUM}_{j}^{link ( {N}_{1} , {N}_{2} )} ( {k}_{1} , {k}_{2} ) ) \qquad ( 10 )$$

MX(τⱼ,N₁,N₂,t) denotes an upper bound on the amount of time that flow τⱼ uses the link from node N₁ to node N₂ during a time interval of length t. Unlike MXS, the function MX is defined for all positive values of t. The function MX, as used herein is:

$$MX ( {τ}_{j} , {N}_{1} , {N}_{2} , t ) = ⌊ \frac{t}{{TSUM}_{j}} ⌋ \times {CSUM}_{j}^{link ( {N}_{1} , {N}_{2} )} + MXS ( {τ}_{j} , {N}_{1} , {N}_{2} , t - ⌊ \frac{t}{{TSUM}_{j}} ⌋ \times {TSUM}_{j} ) \qquad ( 11 )$$

NXS(τⱼ,N₁,N₂,t) denotes an upper bound on the number of Ethernet frames that are received from flow τⱼ from the link from node N₁ to node N₂ during a time interval of length t. (S in NXS means small.) NXS is only defined for values of t such that 0<t<TSUMⱼ. The function NXS as used herein is:

$$NXS ( {τ}_{j} , {N}_{1} , {N}_{2} , t ) = {max}_{{k}_{1} = 0 … {n}_{j} - 1 , {k}_{2} = 1 … {n}_{j} such that {TSUM}_{j} ( {k}_{1} , {k}_{2} ) \leq t} {NSUM}_{j}^{link ( {N}_{1} , {N}_{2} )} ( {k}_{1} , {k}_{2} ) \qquad ( 12 )$$

NX(τⱼ,N₁,N₂,t) denotes an upper bound on the number of Ethernet frames that are received from flow τⱼ from the link from node N₁ to node N₂ during a time interval of length t. Unlike NXS, the function NX is defined for all positive values of t. The function NX as used herein is:

$$NX ( {τ}_{j} , {N}_{1} , {N}_{2} , t ) = ⌊ \frac{t}{{TSUM}_{j}} ⌋ \times {NSUM}_{j} + NXS ( {τ}_{j} , {N}_{1} , {N}_{2} , t - ⌊ \frac{t}{{TSUM}_{j}} ⌋ \times {TSUM}_{j} ) \qquad ( 13 )$$

### First Hop

Recall that the problem is considered from the network operator's perspective and hence we cannot make any assumption on the queuing discipline if the source node is an IP-endhost because the IP-endhost may be a normal PC running a non-real-time operating system and has a queuing discipline in the network stack and queues in the network card that do not take deadlines into account. For this reason, the first hop is analyzed assuming that Ethernet frames on the first link are scheduled by any work-conserving queuing discipline. In the example network (in FIG. 2), the first link is link(0,4).

Let Rᵢ^{k,link(S,succ(τi,S))} denote the response time of frame k in flow τᵢ from the event that all Ethernet frames of frame k of flow τᵢ has been enqueued on node S in the prioritized output queue towards node succ(τᵢ,S) until all Ethernet frames of this frame have been received at node succ(τᵢ,S). Let extraⱼ(N,i) be defined as:

extraⱼ(N,i)=max_{k=0 . . . nj-1}GJⱼ^{k,link(N,succ(τ}^{ᵢ}^{,N}))

The method for computing Rᵢ^{k} explores all messages released from flow τᵢ during a so-called busy-period. The length of the busy period is computed as follows:

tᵢ^{k,link(S,succ(τ}^{ᵢ}^{,S)),0}=0 (14)

and iterate according to:

$${t}_{i}^{k , link ( S , succ ( {τ}_{i} , S ) ) , v + 1} = {\sum }_{j ∈ flows ( S , succ ( {τ}_{i} , S ) )} MX ( {τ}_{j} , S , succ ( {τ}_{i} , S ) , {t}_{i}^{k , link ( S , succ ( {τ}_{i} , S ) ) , v} + {extra}_{j} ( S , i ) ) \qquad ( 15 )$$

When (15) converges with tᵢ^{k,link(S,succ(τi,S)),v+1}=tᵢ^{k,link(S,succ(τi,S)),v} then this is the value of tᵢ^{k,link(S,succ(τi,S))}. It is now possible to compute wᵢ^{k,link(S,succ(τi,S))} the queuing time of the q^{th} message of frame k in the busy period. It is computed iteratively for the following iterative procedure until convergence, wᵢ^{k,link(S,succ(τi,S)),v+1}(q)=wᵢ^{k,link(S,succ(τi,S)),v} (q) is obtained:

wᵢ^{k,link(S,succ(τ}^{ᵢ}^{S)),0}(q)=q×CSUMᵢ^{link(S,succ(τ}^{ᵢ}^{,S))} (16)

and iterate according to:

$${w}_{i}^{k , link ( S , succ ( {τ}_{i} , S ) ) , v + 1} ( q ) = q \times {CSUM}_{i}^{link ( S , succ ( {τ}_{i} , S ) )} + {\sum }_{j ∈ flows ( S , succ ( {τ}_{i} , S ) ) \backslash \{ 1 \}} MX ( {τ}_{j} , S , succ ( {τ}_{i} , S ) , {w}_{i}^{k , link ( S , succ ( {τ}_{i} , S ) ) , v} ( q ) + {extra}_{j} ( S , i ) ) \qquad ( 17 )$$

When (17) converges with wᵢ^{k,link(S,succ(τi,S)),v+1}(q)=wᵢ^{k,link(S,succ(τi,S)),v}(q) then this is the value of wᵢ^{k,link(S,succ(τi,S))}(q). The response-time for the q^{th} arrival of frame k of flow i in the busy period is computed as:

Rᵢ^{k,link(S,succ(τ}^{ᵢ}^{,S))}(q)=wᵢ^{k,link(S,succ(τ}^{ᵢ}^{,S))}(q)−q×TSUMᵢ+Cᵢ^{k} (18)

This is used to calculate the response time:

Rᵢ^{k,link(S,succ(τis i}^{,S))}=(max_{q=0 . . . Q}_{ᵢₖ}₋₁Rᵢ^{k,link(S,succ(τ}^{ᵢ}^{,S))}(q))+prop(S,succ(τᵢ,S)) (19)

where Qᵢ^{k} is defined as:

$${Q}_{i}^{k} = ⌈ \frac{{t}_{i}^{k , link ( S , succ ( {τ}_{i} , S ) )}}{{TSUM}_{i}} ⌉$$

This analysis works for the case that

$${\sum }_{j ∈ flows ( S , succ ( {τ}_{i} , S ) )} \frac{{CSUM}_{j}^{link ( S , succ ( {τ}_{i} , S )}}{{TSUM}_{j}} < 1. \qquad ( 20 )$$

### From Reception to Enqueuing in Priority Queue

FIG. 5 shows the internals of an Ethernet switch. As already described herein the Click software schedules the tasks non-preemptively according to stride scheduling. It can be analyzed as follows. Let NINTERFACES(N) denote the number of network interfaces on node N. (As an illustration, the switch in FIG. 5 has NINTERFACES(N)=4.) Let CROUTE(N) denote the computation time on node N required to dequeue an Ethernet packet from an Ethernet card, find its priority and outgoing queue, and enqueuing the Ethernet frame. Let CSEND(N) denote the computation time on node N required to dequeue an Ethernet frame from the priority queue and then enqueue it to the FIFO queue of the Ethernet card. Consequently, a task is serviced once every NINTERFACES(N)×(CROUTE(N)+CSEND(N)). Let CIRC(N) denote this quantity. In the example in FIG. 5, a task is serviced every 4*(2.7+1) μs; that is every 14.8 μs.

Let Rᵢ^{k,in(N)} denote the response time of frame k in flow τᵢ from the event that the Ethernet frames of frame k of flow τᵢ have been received on node N until all Ethernet frames of this frame have been enqueued in the right priority queue in the Ethernet switch.

The method for computing Rᵢ^{k,in(N)} explores all messages released from flow τᵢ during a so-called busy-period. The length of the busy period is computed as follows:

tᵢ^{k,in(N),0}=0 (21)

and iterated according to:

$${t}_{i}^{k , in ( N ) , v + 1} = {\sum }_{j ∈ flows ( prec ( {τ}_{i} , N ) , N )} NX ( {τ}_{j} , S , prec ( {τ}_{i} , N ) , {t}_{i}^{k , in ( N ) , v} + {extra}_{j} ( S , i ) ) \times CIRC ( N ) \qquad ( 22 )$$

When (22) converges with tᵢ^{k,in(N),v+1}=tᵢ^{k,in(N),v} then this is the value of tᵢ^{k,in(N)}. The quantity wᵢ^{k,in(N)} can now be computed as the queuing time of the q^{th} message of frame k in the level-i busy period. It is computed iteratively until convergence, wᵢ^{k,in(N),v+1}(q)=wᵢ^{k,in(N),v}(q) for the following iterative procedure:

wᵢ^{k,in(N),0}(q)=q×CIRC(N) (23)

and iterated according to:

$${w}_{i}^{k , in ( N ) , v + 1} ( q ) = q \times CIRC ( N ) + {\sum }_{j ∈ flows ( prec ( {τ}_{i} , N ) , N ) \backslash \{ i \}} NX ( {τ}_{j} , S , prec ( {τ}_{i} , N ) , {w}_{i}^{k , in ( N ) ) , v} ( q ) + {extra}_{j} ( S , i ) ) \times CIRC ( N ) \qquad ( 24 )$$

when (24) converges with wᵢ^{k,in(N),v+1}(q)=wᵢ^{k,in(N),v}(q) then this is the value of wᵢ^{k,in(N)}(q). The response-time for the q^{th} arrival of frame k of flow i in the busy period is computed as:

Rᵢ^{k,in(N)}(q)=wᵢ^{k,in(N)}(q)−q×TSUMᵢ+CIRC(N) (25)

This is used to calculate the response time:

Rᵢ^{k,in(N)}=(max_{q=0 . . . Q}_{ᵢₖ}₋₁Rᵢ^{k,in(N)}(q)) (26)

where Qᵢ^{k} is defined as:

$${Q}_{i}^{k} = ⌈ \frac{{t}_{i}^{k , in ( N )}}{{TSUM}_{i}} ⌉ \qquad ( 27 )$$

### From Dequeuing of Priority Queue to Transmission

Consider FIG. 5 again. The time from when all Ethernet frames of the UDP packet are enqueued in the priority queue until all Ethernet frames of the UDP packet have been enqueued in the FIFO queue of the network card of the outgoing link is also of interest. This time depends on the transmission times of priorities with higher priority according to methods known to those skilled in the art.e. This time depends also on the stride scheduling because it can happen that the outgoing link is idle but the task that dequeues an Ethernet frame is not executing and then the outgoing link remains idle although there may be an Ethernet frame in the outgoing queue. For this reason, the corresponding equations are slightly different.

Let Rᵢ^{k,link(N,succ(τi,N))} denote the response time of frame k in flow τᵢ from the event that all the Ethernet frames of frame k of flow τᵢ have been enqueued on node N in the prioritized output queue towards node succ(τᵢ,N) until all Ethernet frames of this frame have been received at node succ(τᵢ,N).

The method for computing Rᵢ^{k,link(N,succ(τi,N))} explores all messages released from flow τᵢ during a so-called level-i busy-period. The length of the level-i busy period is computed as follows:

tᵢ^{k,link(N,succ(τ}^{ⱼ}^{,N)),0}=MFT^{link(N,succ(τ}^{ᵢ}^{,N))} (28)

and iterated according to:

$${t}_{i}^{k , link ( N , succ ( {τ}_{i} , N ) ) , v + 1} = {MFT}^{link ( N , succ ( {τ}_{i} , N ) )} + {\sum }_{j ∈ hep ( N , succ ( {τ}_{i} , N ) )} MX ( {τ}_{j} , N , succ ( {τ}_{i} , N ) , {t}_{i}^{k , link ( N , succ ( {τ}_{i} , N ) ) , v} + {extra}_{j} ( N , i ) ) + {\sum }_{j ∈ hep ( N , succ ( {τ}_{i} , N ) )} NX ( {τ}_{j} , N , succ ( {τ}_{i} , N ) , {t}_{i}^{k , link ( N , succ ( {τ}_{i} , N ) ) , v} + {extra}_{j} ( N , i ) ) \times CIRC ( N ) \qquad ( 29 )$$

When (29) converges with tᵢ^{k,link(N,succ(τi,N)),v+1}=tᵢ^{k,link(N,succ(τi,N)),v} then this is the value of tᵢ^{k,link(N,succ(τi,N))}. It is now possible to compute wᵢ^{k,link(N,succ(τi,N))} the queuing time of the q^{th} message of frame k in the level-i busy period. It is computed iteratively until we obtain convergence, wᵢ^{k,link(N,succ(τi,N)),v+1}(q)=wᵢ^{k,link(N,succ(τi,N)),v}(q) for the following iterative procedure:

wᵢ^{k,link(N,succ(τ}^{ᵢ}^{,N)),0)}(q)=MFT^{link(N,succ(τ}^{ᵢ}^{,N))}+q×CSUMᵢ^{link(N,succ(τ}^{ᵢ}^{,N))} (30)

and iterate according to:

$${w}_{i}^{k , link ( N , succ ( {τ}_{i} , N ) ) , v + 1} ( q ) = {MFT}^{link ( N , succ ( {τ}_{i} , N ) )} + q \times {CSUM}_{i}^{link ( N , succ ( {τ}_{i} , N ) )} + {\sum }_{j ∈ hep ( N , succ ( {τ}_{i} , N ) ) \backslash \{ i \}} MX ( {τ}_{j} , N , succ ( {τ}_{i} , N ) , {w}_{i}^{k , link ( N , succ ( {τ}_{i} , N ) ) , v} ( q ) + {extra}_{j} ( N , i ) ) + {\sum }_{j ∈ hep ( N , succ ( {τ}_{i} , N ) ) \backslash \{ i \}} NX ( {τ}_{j} , N , succ ( {τ}_{i} , N ) , {w}_{i}^{k , link ( N , succ ( {τ}_{i} , N ) ) , v} ( q ) + {extra}_{j} ( N , i ) ) \times CIRC ( N ) \qquad ( 31 )$$

when (31) converges with wᵢ^{k,link(N,succ(τi,N),v+1}(q)=wᵢ^{k,link(N,succ(τi,N)),v}(q) then this is the value of wᵢ^{k,link(N,succ(τi,N))}(q). The response-time for the q^{th} arrival of frame k of flow i in the busy period is computed as:

Rᵢ^{k,link(N,succ(τ}^{ᵢ}^{,N))}(q)=wᵢ^{k,link(N,succ(τ}^{ᵢ}^{,N))}(q)−q×TSUMᵢ+Cᵢ^{k} (32)

This is used to calculate the response time:

Rᵢ^{k,link(N,succ(τ}^{ᵢ}^{,N))}=(max_{q=0 . . . Q}_{ᵢₖ}₋₁Rᵢ^{k,link(N,succ(τ}^{ᵢ}^{,N))}(q))+prop(S,succ(τᵢ,N)) (33)

where Qᵢ^{k} is defined as:

$${Q}_{i}^{k} = ⌈ \frac{{t}_{i}^{k , link ( N , succ ( {τ}_{i} , N ) )}}{{TSUM}_{i}} ⌉$$

This analysis will not converge if

$${\sum }_{j ∈ hep ( N , succ ( {τ}_{i} , N ) ) \backslash \{ i \}} \frac{{CSUM}_{j}^{link ( N , succ ( {τ}_{i} , N ) )}}{{TSUM}_{j}} \geq 1 \qquad ( 34 )$$

This analysis may converge if

$${\sum }_{j ∈ hep ( N , succ ( {τ}_{i} , N ) ) \backslash \{ i \}} \frac{{CSUM}_{j}^{link ( N , succ ( {τ}_{i} , N ) )}}{{TSUM}_{j}} < 1 \qquad ( 35 )$$

### Putting it all Together

Having these equations, the response-time from source to destination of a frame k from flow r can now be calculated. The algorithm shown below computes this assuming that the generalized jitter of all links of all frames of other flows are known.

1. N1 := SOURCE(τᵢ)
2. N2 := succ(τᵢ,N1)
3. RSUM := GJᵢ^{k}; JSUM := GJᵢ^{k}
4. while N2≠DESTINATION(τᵢ) do
5. N3 := succ(τᵢ,N2)
6.
7. if N1= SOURCE(τᵢ) then
8. GJᵢ^{k,link(N1,N2)} := JSUM
9. R := calculate Rᵢ^{k,link(N1,N2)} from (19) based on S=N1
10. RSUM := RSUM + R; JSUM := JSUM + R
11. end if
12.
13. GJᵢ^{k,in(N2)} := JSUM
14. R := calculate Rᵢ^{k,in(N2)} from (26) based on N=N2
15. RSUM := RSUM + R; JSUM := JSUM + R
16.
17. GJᵢ^{k,link(N2,N3)} := JSUM
18. R := calculate Rᵢ^{k,link(N2,N3)} from (33) based on N=N2
19. RSUM := RSUM + R; JSUM := JSUM + R
20.
21. N1 := N2
22. N2 := N3
23. end while
24. Rᵢ^{k} := RSUM

In practice, this assumption is usually false. One can however extend the ideas of holistic schedulability analysis to the case where only the generalized jitter of source nodes are known. It works like this. Assume that the generalized jitter on the source nodes for each flow is what is specified, and assume for every flow that the generalized jitter for links that are not from the source, is zero. Then calculate response times of each resource along the pipeline using the algorithm above. Then let the generalized jitter of a resource be as calculated in the algorithm above. Repeat the process of calculating the response times and updating generalized jitter until the jitter updating leads to the same jitter already assumed. Then the values of Rᵢ^{k} output from the algorithm in the above algorithm can be compared to their deadlines. And this forms an admission controller.

### Hardware

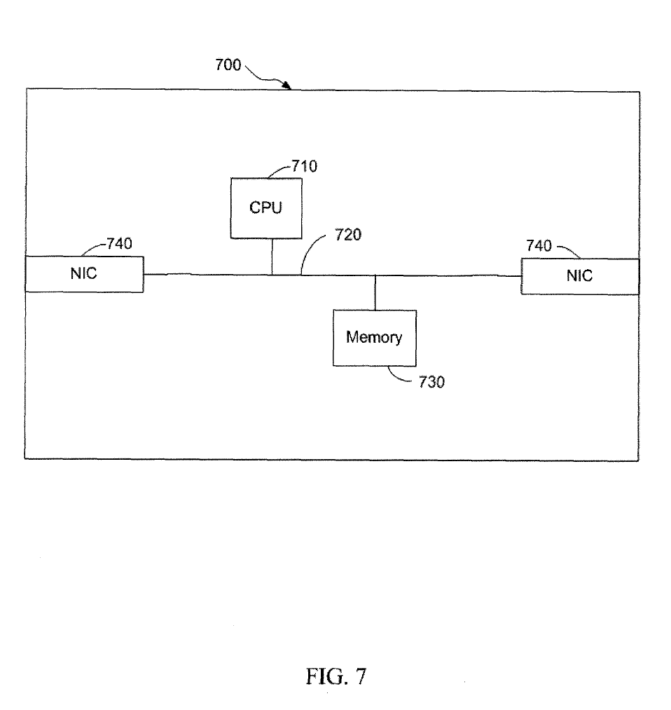

FIG. 7 illustrates one embodiment of the hardware underlying a network node 700. As used herein, a “node” refers to any type of Ethernet switch, IP-router, or IP-endhost, an IP-endhost including any of the varieties of laptop or desktop personal computer, or workstation, or a networked or mainframe computer or super-computer that would be available to one of ordinary skill in the art. According to FIG. 7, a node 700 on which methods of the present technology may be carried out, comprises: at least one processor, such as a central processing unit (CPU) 710 for processing machine readable data, coupled via a bus 720 to a memory 730, and one or more network interfaces 740. Memory 730 comprises a data storage media encoded with machine readable data. Node 700 may also support multiple processors as, for example, in an Intel Core Duo-based system. Additionally, not shown, node 700 may have a user interface. In one embodiment, memory 730 is loaded with instructions for calculating the upper bound to packet delay, as further described herein.

### Data Storage Media

As used herein, “machine readable medium” or “computer readable medium” refers to any media that can be read and accessed directly by a node. Such media include, but are not limited to: magnetic storage media, such as floppy discs, hard discs and magnetic tape; optical storage media such as optical discs; CD-ROM, CD-R or CD-RW, and DVD; electronic storage media such as RAM or ROM; any of the above types of storage media accessible via a network connection; and hybrids of these categories such as magnetic/optical storage media. The choice of the data storage structure will generally be based on the means chosen to access the stored information.

### EXEMPLARY AREAS OF APPLICATION

### Example 1

### GSM and UMTS Networks

GSM (Global System for Mobile communications) is the most popular standard for mobile phones currently in use in the world. The network behind the GSM system seen by the customer is large and complicated in order to provide all of the services which are required. It is divided into a number of sections. One of these sections is the GPRS Core Network, which is an IP packet switching network that allows packet based Internet connections.

Used in Ethernet switches and IP-routers, the technology described herein can be used to improve current GPRS IP backbones. The more recent UMTS (Universal Mobile Telecommunications System) networks share much of the infrastructure with GSM networks, so the discussion herein is applicable to UMTS networks as well.

The GSM Association (GSMA) is a global trade association representing a large number of GSM mobile phone operators. The GSMA has proposed a next generation interconnect solution which they call the IP eXchange (IPX). This new network will be a private IP packet switching network that will allow operators to charge for the delivery of different services. These services include, but are not limited to: IP-telephony/Voice over IP (VoIP), video-conferencing, internet protocol television (IPTV), video-on-demand(VoD), participation in multiuser games and virtual environments, e-commerce, virtual private networks (VPN), and tele-medicine.

The IPX will use a new, standardized software architecture called IMS (IP Multimedia Subsystem). For security reasons the IPX will be disconnected from the Internet. It will also support prioritization of different traffic classes. For example, IP-packets containing voice traffic will be given the highest priority when passing through the IPX. When the IPX is fully implemented, it should be able to replace the GPRS Core Network and the Network Subsystem (NSS) of current GSM networks.

As used in Ethernet switches and IP-routers, the technology described herein can be used to improve future IPX networks. For example, the instant technology can be used to prioritize individual data flows differently. In an IPX network, the data packets of a local VoIP call and a long distance VoIP call will have the same priority. However, the data packets of the long distance call should be assigned a higher priority because they must pass through many more network switches and routers. The technology described herein can be used to assign priorities so that both the local call and the long distance call experience the same end-to-end latency.

### Example 2

### Internet

The Internet and the GSM network have been two separate networks using partly different technologies for transmitting voice and data. It is possible that these two networks will merge or will use the same technologies in the future: IPX networks will probably pose a threat to Internet Service Providers (ISP's) since they can be viewed as a “better Internet”. ISP's might be forced to deploy IMS networks as well. ISP's should be able to use the instant technology in Ethernet switches and IP routers to improve their existing networks as well as future IMS networks.

### Example 3

### Enterprise Networks

The networks of enterprises and other organizations will also contain voice traffic. Although these are smaller networks, it could be beneficial to use the instant technology in corporate LAN Ethernet switches as well, especially if they connect to ISP or IPX networks that use the technology.

### Example 4

### Other Network Applications

At some later stage, it should also be possible to use the instant technology in switches and routers that use wireless channels as well as future mobile base stations, satellites relaying IP traffic, and even mobile phones, if they use packet switching technologies and it is possible to avoid random collisions between data packets when transmitting over the wireless channels. The latter is a requirement so that it is possible to estimate an upper bound on the time to transmit a data packet over the channel.

In time the instant technology could also migrate into host computers and servers connecting to networks that support the technology. Then support for the technology must be added on Network Interface Cards and the Operating System used in these servers and host computers.

There is currently a trend, often called ‘cloud computing’, towards storing documents at a remote server and letting human users access the data through a standard web browser. This allows users to work (for example view or edit) the document at any computer equipped with a standard web browser without the need to install any particular piece of software. Google Does is a good example of such a context. Such distributed systems call for a computer network that offers low delay. The technology described herein helps such applications to offer better user-perceived utility.

### Example 5

### Vehicle Networks—Automobiles

A contemporary car uses many different electronic control units (ECU) to control different functions in the car. For example, different ECU's control and regulate the engine, the gearbox, the four brakes at the wheels, the airbags, etc. The ECU's communicate with each other over different data buses. Typically a CAN-bus (Controller Area Network) is used.

Some messages relate to safety-critical functions and have real-time demands. Therefore, these messages are assigned higher priorities than others. Scheduling theory is used off-line in the laboratory to verify that all time-critical messages can be transferred over the CAN-bus within certain deadlines.

The CAN bus can only transmit at a rate of 1 Mbit/s. For this and other reasons it is possible that the data buses will be replaced by an Ethernet network that can handle real-time communication and guarantee that transmission times of time-critical messages are within certain deadlines.

For more information, see, for example, “BMW Develops IP-based Networking for Next Gen Vehicles” (available at wvvw.dailytech.com/article.aspx?newsid=9884).

### Example 6

### Vehicle Networks—Aircraft

Aircraft also use ECU's and data buses to some extent, so the discussion regarding automobiles should also be applicable to aircraft, including both commercial and military craft.

### Example 7

### Vehicle Networks—Future Traffic Control and Safety Systems

One can envision traffic control and safety systems in the future in which a car is part of a wireless network communicating with other cars in its vicinity and with base stations along the road. For example, if two cars collide, then these cars immediately broadcast messages to approaching vehicles, and certain ECU's in these cars activate their brakes so as to avoid further collisions. In such a system, the in-vehicle Ethernet network becomes part of a larger network. The whole network must dynamically perform schedulability analysis and estimate end-to-end latency for transmitting high priority messages between different cars. The technology described herein would be beneficial to use in such a traffic system.

### Example 8

### Automation and Process Control

Ethernet networks are applied to factories to control and supervise, e.g., assembly lines and chemical processes. If some of the data transported in these networks has real-time demands, it could be beneficial to apply the technology described herein in such industrial Ethernet networks.

### Example 9

### Power Distribution

There exist distributed computer systems that supervise and control power distribution in the electrical net. It could be beneficial to apply the technology described herein in the network that connects the computers in this distributed computer system.

### Example 10

### Military and Defense Applications

The technology described herein can be applied to military systems such as missile guidance systems, missile defense systems and tactical military networks, i.e., networks that distribute intelligence information amongst all combat units in a geographical area. See, e.g., Operax Defense Solutions for more information (available at www.operax.se/operaxresourcem/operaxresourcem.asp).

### Example 11

### Stock Trading

Trading of stocks, resources etc., within the financial sector is at times characterized by fast fluctuations in prices. Day traders try to exploit even small fluctuations in stock prices and sometimes own a stock for just a few minutes or even seconds. On these small time scales, for the trading to be completely fair, a requirement is that information about, e.g., the number of stocks offered at a certain price reaches the traders at exactly the same instant in time. In its extreme, a requirement is that the price information broadcasted from a server reaches all destination hosts with the same latency. One can envision a future in which computers perform all trading without human intervention. Then stock-trading truly will be an application exhibiting real-time demands and the technology described herein would be beneficial to apply in networks transporting financial information, stock orders etc.

### Example 12

### Other Areas of Application Include

Broadcast and media networks used by broadcasters and media production companies to transport video and do real time video editing.

Internal networks in hospitals connecting, e.g., medical equipment and life sustaining systems and at the same time allowing VoIP communication.

Aircraft guidance, control and landing systems are other areas of application of networking technology where packet delay estimation, as described herein, may find application.

A number of embodiments of the technology have been described. Nevertheless, it will be understood that various modifications may be made without departing from the spirit and scope of the technology. For example, multiframe flows and network topologies other than those described may be handled via different formulas. Accordingly, other embodiments are within the scope of the following claims.

### RELATED PUBLICATIONS

Each of the below-listed publications is incorporated herein in its entirety. The presence of a reference in this list is not to be taken as an admission that the reference is prior art as of the filing date of the instant application.
1. “Telefonkaos i Region Skåne,” in Svenska dagbladet, 2007.
2. J. Evans and C. Filsfils, “Deploying Diffsery at the Network Edge for Tight SLAs, Part 1,” in IEEE Internet Computing., vol. 8, 2004, pp. 61-65.
3. B. Turner, “Why There's No Internet QoS and Likely Never Will Be,” in Internet Telephony Magazine, vol. 10, 2007.
4. R. Braden, L. Zhang, S. Berson, S. Herzog, and S. Jamin, “Resource ReSerVation Protocol (RSVP)—Version 1 Functional Specification”, RFC 2205,” 1997.
5. K. Tindell and J. Clark, “Holistic schedulability analysis for distributed hard real-time systems,” Microprocessing and Microprogramming, vol. 40, pp. 117-134, 1994.
6. S. Baruah, D. Chen, S. Gorinsky, and A. Mok, “Generalized multiframe tasks,” Real-Time Systems, vol. 17, pp. 5-22, 1999.
7. E. Kohler, R. Morris, B. Chen, J. Jannotti, and M. F. Kaashoek, “The Click modular router,” ACM Transactions on Computer Systems, vol. 18, pp. 263-297, 2000.
8. C. A. Waldspurger and W. E. Weihl, “Stride Scheduling: Deterministic Proportional-Share Resource Management,” MIT Laboratory for Computer Science June 1995.
9. P. Baran, “On distributed communications networks,” IEEE Transactions on Communications, pp. 1-9, 1964.
10. A. Demers, S. Keshav, and S. Shenker, “Analysis and simulation of a fair queueing algorithm,” presented at Communications architectures & protocols Applications, Technologies, Architectures, and Protocols for Computer Communication Symposium, Austin, Tex., United States, 1989.
11. A. K. Parekh and R. G. Gallager, “A generalized processor sharing approach to flow control in integrated services networks: the single-node case,” IEEE/ACM Transactions on Networking, vol. 1, pp. 344-357, 1993.
12. R. L. Cruz, “A Calculus for Network Delay. Part I: Network Elements in Isolation,” IEEE Transactions on Information Theory, vol. 37, pp. 114-141, 1991.
13. D. Ferrari and D. C. Verma, “A scheme for real-time channel establishment in wide-area networks,” IEEE Journal on Selected Areas in Communications vol. 8, pp. 368-379, 1990.
14. “Bosch, “CAN Specification, ver. 2.0, Robert Bosch GmbH, Stuttgart”, 1991, online at: http://www.semiconductors.bosch.de/pdf/can2spec.pdf.
15. R. I. Davis, A. Burns, R. J. Bril, and J. J. Lukkien, “Controller Area Network (CAN) schedulability analysis: Refuted, Revisited and Revised,” Real-Time Systems, vol. 35, pp. 239-272, 2007.
16. K. Tindell, H. Hansson, and A. Wellings, “Analysing real-time communications: Controller Area Network (CAN),” presented at 15th Real-Time Systems Symposium (RTSS'94), 1994.
17. J. Loeser and H. Haertig, “Low-latency hard real-time communication over switched Ethernet,” presented at 16th Euromicro Conference on Real-Time Systems, Catania, Italy, 2004.
18. K. Steinhammer, P. Grillinger, A. Ademaj, and H. Kopetz, “A time-triggered ethernet (TTE) switch,” presented at conference on Design, automation and test in Europe, Munich, Germany, 2006.
19. P. Pedreiras, P. Gai, L. Almeida, and G. Buttazzo, “FTT-Ethernet: A Flexible Real-Time Communication Protocol That Supports Dynamic QoS Management on Ethernet-Based Systems,” IEEE Transactions on Industrial Informatics, vol. 1, pp. 162-172, 2005.

1-66. (canceled)

67. A method for calculating the end-to-end delay of a multiframe real-time flow along a route in a multihop network, the method comprising:
selecting the route in the multihop network, wherein the multiframe real-time flow is capable of being transmitted along the route, the route comprising a source node in the multihop network, a destination node in the multihop network, and at least one intermediate node in the multihop network, the source node comprising either an IP-endhost or an IP-router, the destination node comprising either an IP endhost or an IP-router, and the multiframe real-time flow comprising one or more frames; and
determining an upper bound of a time required to transmit the multiframe real-time flow from the source node to the destination node along the route.

68. The method of claim 67, further comprising determining whether it is possible to offer a delay guarantee for transmission the multiframe real-time flow, wherein the delay conforms to a specified deadline for arrival of the multiframe real-time flow at the destination node, given the upper bound of the time required to transmit the multiframe real-time flow from the source node to the destination node along the route.

69. The method of claim 68, further comprising if it is possible to offer the delay guarantee for transmission of the multiframe real-time flow along the route, transmitting the multiframe real-time flow along the route.

70. The method of claim 68, further comprising if it is possible to offer the delay guarantee for transmission of the multiframe real-time flow along the route, allowing transmission of the multiframe real-time flow.

71. The method of claim 68, further comprising if it is not possible to offer the delay guarantee for transmission of the multiframe real-time flow along the route, denying transmission of the multiframe real-time flow.

72. The method of claim 68, further comprising scheduling transmission of the multiframe real-time flow at a particular time, wherein the particular time at which transmission of the multiframe real-time flow is scheduled is based, at least in part, upon a determination of whether it is possible to offer the delay guarantee for transmission of the multiframe real-time flow along the route.

73. The method of claim 68, further comprising queuing transmission of the multiframe real-time flow, wherein queuing is performed in a manner based, at least in part, upon a determination of whether it is possible to offer the delay guarantee for transmission of the multiframe real-time flow along the route.

74. The method of claim 73, wherein queuing transmission of the multiframe real-time flow is performed in a manner based, at least in part, upon a priority of the multiframe real-time flow.

75. The method of claim 68, further comprising:
if it is not possible to offer the delay guarantee for the multiframe real-time flow, determining whether there is a second route in the multihop network along which the multiframe real-time flow could be transmitted from the source node to the destination node; and
if a second route exists, determining an upper bound of a time required to transmit the multiframe real-time flow from the source node to the destination node along the second route, wherein the upper bound includes delay attributable to generalized jitter.

76. The method of claim 68, further comprising transmitting a message, based upon a determination of whether it is possible to offer the delay guarantee for transmission of the multiframe real-time flow along the route.

77. The method of claim 67, wherein determining the upper bound of the time required to transmit the multiframe real-time flow comprises:
determining a response time required to transmit the frame of the multi frame real-time flow across a first hop of the route, wherein the first hop comprises a link from the source node to a successive node, wherein the determining comprises calculating the response time according to
Rᵢ^{k,link(S,succ(τ}^{ᵢ}^{,S))}=(max_{q=0 . . . Q}_{ᵢₖ}₋₁Rᵢ^{k,link(S,succ(τ}^{ᵢ}^{,S))}(q))+prop(S,succ(τᵢ,S))
where Qᵢ^{k} is defined as:
$${Q}_{i}^{k} = [ \frac{{t}_{i}^{k , link ( S , succ ( {τ}_{i} , S ) )}}{{TSUM}_{i}} ] ,$$
and wherein the response time begins from a moment when all Ethernet frames comprising a frame of the multiframe real-time flow have been enqueued on the source node in a prioritized output queue towards the successive node in the route and ends at a moment when all the Ethernet frames have been received at the successive node.

78. The method of claim 77, wherein determining the response time comprises determining transmission times for all the Ethernet frames comprising the frame of the multiframe real-time flow, according to a speed of a link for transmitting an Ethernet frame.

79. The method of claim 77, wherein determining the response time comprises determining generalized jitter for each of the Ethernet frames comprising the frame of the multiframe real-time flow as each Ethernet frame is transmitted across the first hop.

80. The method of claim 67, wherein determining the upper bound of the time required to transmit the multiframe real-time flow further comprises determining a response time required to transmit a frame of the multi frame real-time flow across a non-first hop of the route.

81. The method of claim 80, wherein determining the response time required to transmit a frame of the multiframe real-time flow across a non-first hop comprises:
determining a first response time, wherein the determining comprises calculating the first response time according to
Rᵢ^{k,in(N)}=(max_{q=0 . . . Q}_{ᵢₖ}₋₁Rᵢ^{k,in(N)}(q))
and wherein the first response time is measured from a moment when all Ethernet frames comprising a frame of the multiframe real-time flow have been received at a first node until a moment when all the Ethernet frames have been enqueued in a correct priority queue in the first node; and
determining a second response time, wherein the determining comprises calculating the second response time according to
Rᵢ^{k,link(N,succ(τ}^{ᵢ}^{,N)}=(max_{q=0 . . . Q}_{ᵢₖ}₋₁Rᵢ^{k,link(N,succ(τ}^{ᵢ}^{,N))}(q))+prop(S,succ(τᵢ,N))
and wherein the second response time is measured from a moment when all Ethernet frames comprising the frame of the multiframe real-time flow have been enqueued in the correct priority queue in the first node until a moment when all the Ethernet frames have been received at a successive node.

82. The method of claim 81, wherein determining the first response time comprises determining generalized jitter for each of the Ethernet frames.

83. The method of claim 81, wherein determining the second response time comprises determining transmission times for all the Ethernet frames, according to a speed of a link for transmitting an Ethernet frame; and determining generalized jitter for each of the Ethernet frames.

84. A method for analyzing schedulability of a multiframe real-time flow in a multihop network, the method comprising:
selecting a route in the multihop network, wherein the multiframe real-time flow is capable of being transmitted along the route, the route comprising a source node in the multihop network, a destination node in the multihop network, and at least one intermediate node in the multihop network, the source node comprising either an IP-endhost or an IP-router, the destination node comprising either an IP-endhost or an IP-router, and the multiframe flow comprising one or more frames;
looking up an end-to-end delay of the multiframe real-time flow along the route in the multihop network; and
determining whether it is possible to offer a delay guarantee for the multiframe real-time flow, wherein the delay conforms to a specified deadline for arrival of the multiframe real-time flow at the destination node, given an upper bound of a time required to transmit the multiframe real-time flow from the source node to the destination node along the route.

85. The method of claim 84, wherein looking up the end-to-end delay of the multiframe real-time flow along the route in the multihop network comprises accessing another node in the network, wherein the end-to-end delay of the multiframe real-time flow along the route in the multihop network is stored on the other node.

86. The method of claim 84, wherein looking up the end-to-end delay of the multi frame real-time flow along the route in the multihop network comprises accessing a database, wherein the end-to-end delay of the multiframe real-time flow along the route in the multihop network is stored in the database.

87. The method of claim 84, wherein looking up the end-to-end delay of the multiframe real-time flow along the route in the multihop network comprises accessing an in-memory lookup table, wherein the end-to-end delay of the multiframe real-time flow along the route in the multihop network is stored in the in-memory lookup table.

88. The method of claim 84, further comprising if it is possible to offer the delay guarantee for transmission of the multiframe real-time flow along the route, transmitting the multiframe real-time flow along the route.

89. The method of claim 84, further comprising if it is possible to offer the delay guarantee for transmission of the multi frame real-time flow along the route, allowing transmission of the multiframe real-time flow.

90. The method of claim 84, further comprising if it is not possible to offer the delay guarantee for transmission of the multiframe real-time flow along the route, denying transmission of the multiframe real-time flow.

91. The method of claim 84 further comprising scheduling transmission of the multiframe real-time flow at a particular time, wherein the particular time at which transmission of the multiframe real-time flow is scheduled is based, at least in part, upon a determination of whether it is possible to offer the delay guarantee for transmission of the multiframe real-time flow along the route.

92. The method of claim 84, further comprising queuing transmission of the multiframe real-time flow, wherein queuing is performed in a manner based, at least in part, upon a determination of whether it is possible to offer the delay guarantee for transmission of the multiframe real-time flow along the route.

93. The method of claim 92, wherein queuing transmission of the multiframe real-time flow is performed in a manner based, at least in part, upon a priority of the multiframe real-time flow.

94. The method of claim 84, further comprising:
if it is not possible to offer the delay guarantee for the multiframe real-time flow, determining whether there is a second route in the multihop network along which the multiframe real-time flow could be transmitted from the source node to the destination node; and
if a second route exists, determining an upper bound of a time required to transmit the multiframe real-time flow from the source node to the destination node along the second route, wherein the upper bound includes delay attributable to generalized jitter.

95. The method of claim 84, further comprising transmitting a message, based upon a determination of whether it is possible to offer the delay guarantee for transmission of the multiframe real-time flow along the route.

96. A computer-readable medium, on which is stored a computer program for calculating an upper bound of the time required to transmit a multi frame real-time flow along a route in a multihop network, the computer program comprising instructions for causing a computer to:
receive input selecting the route in the multihop network, wherein the multiframe real-time flow is capable of being transmitted along the route, the route comprising a source node in the multihop network, a destination node in the multihop network, and at least one intermediate node in the multihop network, the source node comprising either an IP-endhost or an IP-router, the destination node comprising either an IP-endhost or an IP-router, and the multiframe flow comprising one or more frames; and
calculate an upper bound of the time required to transmit the multiframe real-time flow from the source node to the destination node along the route.

97. The computer-readable medium of claim 96, wherein determining the upper bound of the time required to transmit the multiframe real-time flow comprises:
determining a response time required to transmit the frame of the multiframe real-time flow across a first hop of the route, wherein the first hop comprises a link from the source node to a successive node, wherein the determining comprises calculating a formula according to
Rᵢ^{k,link(S,succ(τ}^{ᵢ}^{,S))}=(max_{q=0 . . . Q}_{ᵢₖ}₋₁Rᵢ^{k,link(S,succ(τ}^{ᵢ}^{,S))}(q))+prop(S,succ(τ^{ᵢ}^{,S))}
where Qᵢ^{k} is defined as:
$${Q}_{i}^{k} = [ \frac{{t}_{i}^{k , link ( S , succ ( {τ}_{i} , S ) )}}{{TSUM}_{i}} ]$$
and wherein the response time begins from the moment when all Ethernet frames comprising the frame of the multiframe real-time flow have been enqueued on the source node in the prioritized output queue towards the successive node in the route and ends at the moment when all the Ethernet frames have been received at the successive node.

98. The computer-readable medium of claim 97, wherein determining the response time comprises determining transmission times for all the Ethernet frames comprising the frame of the multiframe real-time flow, according to the speed of the link for transmitting an Ethernet frame.

99. The computer-readable medium of claim 98, wherein determining the response time comprises determining generalized jitter for each of the Ethernet frames comprising the frame of the multiframe real-time flow as each Ethernet frame is transmitted across the first hop.

100. The computer-readable medium of claim 97, wherein determining the upper hound of the time required to transmit the multi frame real-time flow further comprises determining the response time required to transmit a frame of the multi frame real-time flow across a non-first hop of the route.

101. The computer-readable medium of claim 100, wherein determining the response time required to transmit a frame of the multiframe real-time flow across a non-first hop comprises:
determining a first response time, wherein the determining comprises calculating a formula according to
Rᵢ^{k,in(N)}=(max_{q=0 . . . Q}_{ᵢₖ}₋₁Rᵢ^{k,in(N)}(q))
and wherein the first response time is measured from the moment when all Ethernet frames comprising the frame of the multiframe real-time flow have been received at a first node until the moment when all the Ethernet frames have been enqueued in the correct priority queue in the first node; and
determining a second response time, wherein the determining comprises calculating a formula according to
Rᵢ^{k,link(N,succ(τ}^{ᵢ}^{,N)}=(max_{q=0 . . . Q}_{ᵢₖ}₋₁Rᵢ^{k,link(N,succ(τ}^{ᵢ}^{,N))}(q))+prop(S,succ(τᵢ,N))
and wherein the second response time is measured from the moment when all Ethernet frames comprising the frame of the multiframe real-time flow have been enqueued in the correct priority queue in the first node until the moment when all the Ethernet frames have been received at a successive node.

102. The computer-readable medium of claim 101, wherein determining the first response time comprises determining generalized jitter for each of the Ethernet frames.

103. The computer-readable medium of claim 101, wherein determining the second response time comprises:
determining transmission times for all the Ethernet frames, according to the speed of the link for transmitting an Ethernet frame; and
determining generalized jitter for each of the Ethernet frames.

104. A system for calculating an upper hound of the time required to transmit a multiframe real-time flow along a route in a multihop network, the system comprising:
a memory; and
a processor,
wherein the memory is encoded with instructions that, when executed, cause the processor to:
receive input selecting the route in the multihop network, wherein the multiframe real-time flow is capable of being transmitted along the route, the route comprising a source node in the multihop network, a destination node in the multihop network, and at least one intermediate node in the multihop network, the source node comprising either an IP-endhost or an IP-router, the destination node comprising either an IP-endhost or an IP-router, and the multiframe flow comprising one or more frames; and
calculate an upper bound of the time required to transmit the multiframe real-time flow from the source node to the destination node along the route.

105. The system of claim 104, wherein the memory is further encoded with instructions to determine whether it is possible to offer a delay guarantee for the multi frame real-time flow, wherein the delay conforms to a specified deadline for the arrival of the multiframe real-time flow at the destination node, given the upper bound of the time required to transmit the multiframe real-time flow from the source node to the destination node along the route.

106. The system of claim 105, wherein the memory is further encoded with instructions to if it is possible to offer the delay guarantee for transmission of the multiframe real-time flow along the route, transmit the multiframe real-time flow along the route.

107. The system of claim 105, wherein the memory is further encoded with instructions to if it is possible to offer the delay guarantee for transmission of the multiframe real-time flow along the route, allow transmission of the multiframe real-time flow.

108. The system of claim 105, wherein the memory is further encoded with instructions to if it is not possible to offer the delay guarantee for transmission of the multiframe real-time flow along the route, deny transmission of the multiframe real-time flow.

109. The system of claim 105, wherein the memory is further encoded with instructions to schedule transmission of the multiframe real-time flow at a particular time, wherein the time at which transmission of the multiframe real-time flow is scheduled is based at least in part upon the determination of whether it is possible to offer the delay guarantee for transmission of the multiframe real-time flow along the route.

110. The system of claim 105, wherein the memory is further encoded with, instructions to queue transmission of the multiframe real-time flow, wherein queuing is performed in a manner based at least in part upon the determination of whether it is possible to offer the delay guarantee for transmission of the multiframe real-time flow along the route.

111. The system of claim 110, wherein queuing transmission of the multiframe real-time flow is performed in a manner based at least in part upon the priority of the multiframe real-time flow.

112. The system of claim 105, wherein the memory is further encoded with instructions to:
if it is not possible to offer the delay guarantee for the multiframe real-time flow, determine whether there is a second route in the multihop network along which the multiframe real-time flow could be transmitted from the source node to the destination node; and
if a second route exists, determine an upper bound of the time required to transmit the multiframe real-time flow from the source node to the destination node along the second route, wherein the upper bound includes delay attributable to generalized jitter.

113. The system of claim 105, wherein the memory is further encoded with instructions to transmit a message, based upon the determination of whether it is possible to offer the delay guarantee for transmission of the multiframe real-time flow along the route.

114. The system of claim 104, wherein the instructions to determine the upper bound of the time required to transmit the multiframe real-time flow comprise instruct ions to:
determine a response time required to transmit the frame of the multi frame real-time flow across a first hop of the route, wherein the first hop comprises a link from the source node to a successive node, wherein the determining comprises calculating a formula according to
Rᵢ^{k,link(S,succ(τ}^{ᵢ}^{,S))}=(max_{q=0 . . . Q}_{ᵢₖ}₁₋Rᵢ^{k,link(S,succ(τ}^{ᵢ}^{,S))}(q))+prop(S,succ(τᵢ,S))
where Qᵢ^{k} is defined as:
$${Q}_{i}^{k} = [ \frac{{t}_{i}^{k , link ( S , succ ( {τ}_{i} , S ) )}}{{TSUM}_{i}} ]$$
and wherein the response time begins from the moment when all Ethernet frames comprising the frame of the multiframe real-time flow have been enqueued on the source node in the prioritized output queue towards the successive node in the route and ends at the moment when all the Ethernet frames have been received at the successive node.

115. The system of claim 114, wherein the instructions for determining the response time comprise instructions to determine transmission times for all the Ethernet frames comprising the frame of the multiframe real-time flow, according to the speed of the link for transmitting an Ethernet frame.

116. The system of claim 114, wherein the instructions for determining the response time comprise instructions to determine generalized jitter for each of the Ethernet frames comprising the frame of the multiframe real-time flow as each Ethernet frame is transmitted across the first hop.

117. The system of claim 104, wherein the instructions for determining the upper bound of the time required to transmit the multi frame real-time flow further comprise instructions to determine the response time required to transmit a frame of the multiframe real-time flow across a non-first hop of the route.

118. The system of claim 117, wherein the instructions for determining the response time required to transmit a frame of the multiframe real-time flow across a non-first hop comprise instructions to:
determine a first response time, wherein the determining comprises calculating a formula according to
Rᵢ^{k,in(N)}=(max_{q=0 . . . Q}_{ᵢₖ}₋₁Rᵢ^{k,in(N)}(q))
and wherein the first response time is measured from the moment when all Ethernet frames comprising the frame of the multiframe real-time flow have been received at a first node until the moment when all the Ethernet frames have been enqueued in the correct priority queue in the first node; and
determining a second response time, wherein the determining comprises calculating a formula according to
Rᵢ^{k,link(N,succ(τ}^{ᵢ}^{,N)}=(max_{q=0 . . . Q}_{ᵢₖ}₋₁Rᵢ^{k,link(N,succ(τ}^{ᵢ}^{,N))}(q))+prop(S,succ(τᵢ, N))
and wherein the second response time is measured from the moment when all Ethernet frames comprising the frame of the multi frame real-time flow have been enqueued in the correct priority queue in the first node until the moment when all the Ethernet frames have been received at a successive node.

119. The system of claim 118, wherein the instructions for determining the first response time further comprise instructions to determine generalized jitter for each of the Ethernet frames.

120. The system of claim 118, wherein the instructions for determining the second response time further comprise instructions to:
determine transmission times for all the Ethernet frames, according to the speed of the link for transmitting an Ethernet frame; and
determine generalized jitter for each of the Ethernet frames.
